(19) United States
(12) Patent Application Publication
(10) Pub. No.: US 2006/0106700 A1
(43) Pub. Date: May 18, 2006

(54) Investment analysis and reporting system and method

(76) Inventors: Michael K. Boren, Boise, ID (US); David R. Boren, Boise, ID (US); Douglas K. Bates, Boise, ID (US); Christopher J. Growney, Boise, ID (US); Charles David Dunn, Boise, ID (US); James Timothy Dunn, Boise, ID (US); Jerek J. Anderson, Boise, ID (US); Paul David Price, Boise, ID (US); Brian Andrew Hill, Boise, ID (US); Justin Kelly Reed, Boise, ID (US); James D. Price, Boise, ID (US)

Correspondence Address: Peter M. Midgley;HOLLAND & MIDGLEY, LLP, P.O. Box 1840, Boise, ID, 83701-1840, US

(21) Appl. No.: 11/076,310

(22) Filed: Mar. 8, 2005

Related U.S. Application Data
(60) Provisional application No. 60/627,671, filed on Nov. 12, 2004.

(51) Int. Cl. G07F 19/00; G06Q 40/00; G07B 17/00

(52) U.S. Cl. 705/35; 705/30

(57) ABSTRACT

A method and system for analyzing and reporting institutional investments provides a single platform for daily investment accounting, compliance, performance, and risk reports for investment portfolios held at single or multiple custody/safekeeping locations. The method involves retrieving transaction data from multiple independent financial institutions and storing it in a database in a standardized format and retrieving security data from one or more security information service providers and storing it in the database. The method further involves applying a uniform set of customized accounting, compliance, risk and performance parameters to the transaction data and security data stored in the database and, in response to a user request, calculating and reporting selected data to the user in accordance with the uniform accounting, compliance, risk and performance parameters.

### RELATED APPLICATIONS

This non-provisional application is related to and claims priority to Provisional Application No. 60/627,671 filed on Nov. 12, 2004, entitled FINANCIAL MANAGEMENT SYSTEM AND METHOD, the contents of which is fully incorporated herein by reference.

### TECHNICAL FIELD

This application relates in general to investment analysis and reporting tools and, more specifically, to investment analysis and reporting tools for institutional investors.

### BACKGROUND

Institutional investors include a wide variety of organizations, such as corporate pension plans, state and local governments, insurance companies, endowments, foundations, trusts, family offices, and corporate liquidity portfolios. These organizations typically strive to develop and implement detailed investment strategies that are designed to produce maximum return on investment while keeping risk within acceptable limits.

Because institutional investment portfolios frequently involve large sums of money, it is common for an institutional investor to subdivide a portfolio into multiple sub-accounts that are maintained with several different custody banks or other financial institutions. In addition, institutional investors often delegate the day-to-day management responsibilities for different portions of their portfolios to different money managers as part of their overall investment strategies.

There can be significant variations in the way that data is maintained and reported by different custody/safekeeping banks and money managers. For example, different providers may apply different accounting and risk assumptions or performance calculations when analyzing data and reporting it to an investor. Thus, it is typically a time-consuming and inconvenient process for an institutional investor to aggregate, synthesize and reconcile all of the information it receives from various sources using various methodologies for reporting portfolio accounting, compliance, risk and performance. As a result, it can be very difficult for an institutional investor to accurately and efficiently report investment accounting, monitor portfolio investment policy or regulatory compliance and evaluate the risk and performance of different money managers efficiently or to conduct meaningful analyses of its overall investment strategy.

### SUMMARY OF THE INVENTION

In view of the above-mentioned drawbacks associated with existing financial management methods for institutional investors, there is a need for a financial management process and system that will enable institutional investors to quickly and efficiently retrieve and analyze information from multiple sources, such as custody/safekeeping banks, money managers, etc. The drawbacks mentioned above are addressed by embodiments of the present invention, which will be understood by reading and studying the following specification.

In one embodiment, a management terminal of an institutional investment analysis and reporting system comprises an input/output module configured to retrieve and/or extract data from a plurality of disparate data sources in communication with the management terminal via a telecommunications network. The management terminal further comprises a database configured to store data retrieved from the data sources, a reconciliation module configured to identify and correct inconsistencies in data stored in the database, and an accounting module configured to generate accounting reports from data stored in the database. The management terminal further comprises a compliance module configured to generate compliance reports from data stored in the database, a risk module configured to generate risk reports from data stored in the database, and a performance module configured to generate performance reports from data stored in the database.

In another embodiment, a method for analyzing and reporting institutional investments comprises retrieving transaction data from multiple independent financial institutions and storing it in a database in a standardized format, retrieving security data from one or more security information service providers and storing it in the database, and automatically reconciling the retrieved transaction and security data and notifying the user of discrepancies. The method further comprises receiving a user request from a user terminal in communication with a management terminal via a telecommunications network, for a selected report of data stored within the database. In response to the user request, the selected report is generated by compiling data retrieved from the multiple independent financial institutions, and the report is displayed to the user.

In another embodiment, a method for reporting institutional investment information comprises enabling a user to select a report of data related to any individual or all of the following characteristics of an institutional investment account: (a) accounting, (b) compliance, (c) risk, and (d) performance. The method further comprises initially displaying a first report of the selected data at a summary level, receiving a user request for more detailed information about the summary data displayed in the first report, and in response to the user request, displaying a second, third or fourth report at a detailed level showing information about one or more specific securities within the institutional investment account.

In another embodiment, a method for analyzing and reporting institutional investments comprises retrieving transaction data from multiple independent financial institutions and storing it in a database in a standardized format and retrieving security data from one or more security information service providers and storing it in the database. The method further comprises applying a uniform set of accounting, compliance, risk and performance parameters to the transaction data and security data stored in the database and, in response to a user request, calculating and reporting selected data to the user in accordance with the uniform accounting, compliance, risk and performance parameters.

In another embodiment, a method of monitoring compliance in an institutional investment system comprises establishing a plurality of compliance rules for a user account based at least in part on inputs received from the user in response to investment policy, regulatory or statutory investment guidelines, wherein one or more of the compliance rules is based on accounting and/or risk parameters. The method further comprises monitoring real-time and/or daily activity within the user account to detect violations of the compliance rules for the account on a daily basis and notifying the user of compliance rule violations immediately or within one day of when such violations are detected.

The details of one or more embodiments of the claimed invention are set forth in the accompanying drawings and the description below. Other features and advantages will become apparent from the description, the drawings, and the claims.

### BRIEF DESCRIPTION OF THE DRAWINGS

FIG. 1 illustrates one embodiment of a financial management system.

FIG. 2 illustrates one embodiment of a process for updating the Index Data table.

FIG. 3 illustrates one embodiment of a screen that may be displayed by the management terminal.

Like reference numbers and designations in the various drawings indicate like elements.

### DETAILED DESCRIPTION OF THE PREFERRED EMBODIMENT

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

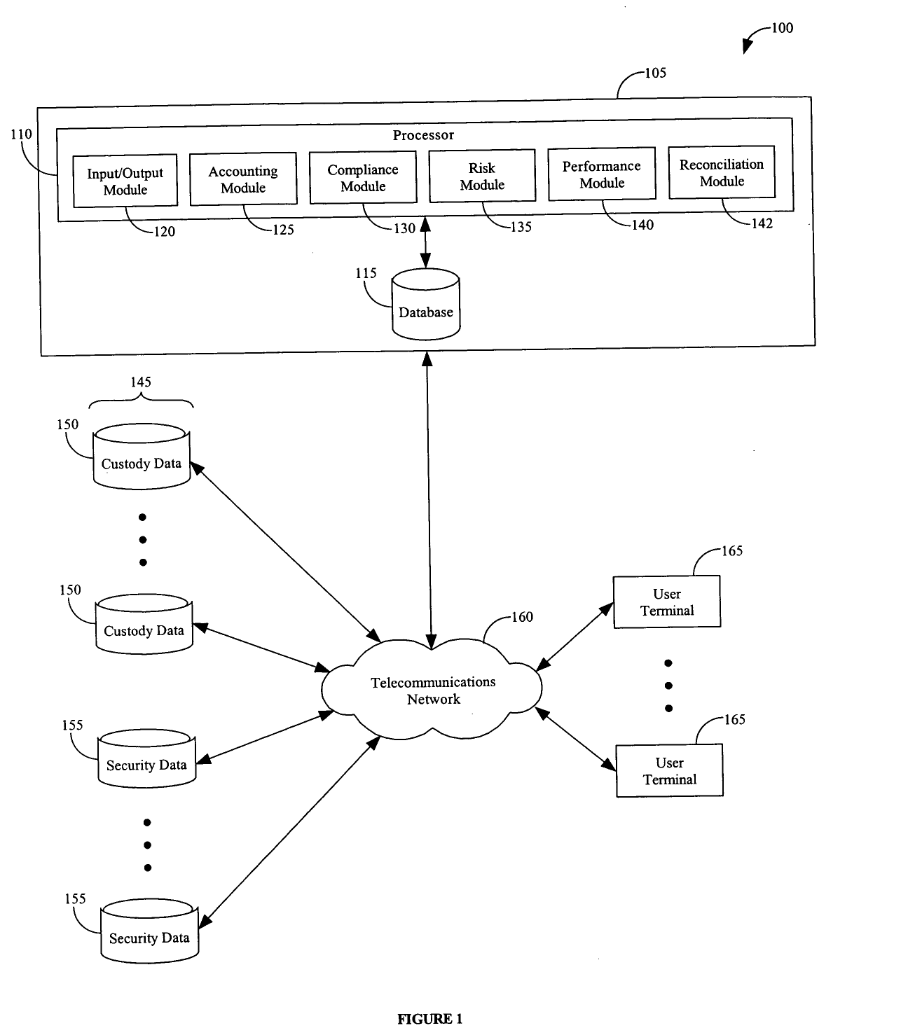

FIG. 1 illustrates one embodiment of a financial management system 100. In the illustrated embodiment, the system 100 includes a management terminal 105 comprising a processor 110 and a database 115. The processor 110 comprises a number of modules, such as, for example, an input/output module 120, an accounting module 125, a compliance module 130, a risk module 135, a performance module 140, and a reconciliation module 142. The operation of each of these modules is discussed in more detail below.

The system 100 also includes a plurality of data sources 145, such as, for example, custody data sources 150 and security data sources 155. Each custody data source 150 is maintained independently by a third-party custody bank or money manager, such as State Street, Bank of New York, or Wells Fargo. These custody data sources 150 typically contain information about accounts and transactions and cash flows handled by the respective custody banks or money managers, and this information is often updated in real time as new transactions are processed.

The security data sources 155 contain information about individual securities, such as a unique identifier, issuer, coupon, maturity date, price, duration, yield, credit rating, etc. The securities may comprise a wide range of investment instruments, such as, for example, money market funds, commercial paper, CDs, time deposits, treasuries, bonds, auction rate preferred notes, etc. The security data sources 155 may also contain information regarding equity products, such as stocks, or derivative investment products, such as, for example, options, swaps, futures, etc. The security information is compiled from numerous publicly-available data sources by various security information service providers, such as Merrill Lynch and Goldman Sachs. The data sources 145 are in communication with the management terminal 105 through a telecommunications network 160, such as, for example, the Internet.

The system 100 also comprises a plurality of user terminals 165 in communication with the management terminal 105 via the telecommunications network 160. In some embodiments, the user terminals 165 may comprise desktop computers, laptop computers, network appliances, personal digital assistants, cellular telephones, or other devices that can be used by individual users to gain access to the management terminal 105 through the telecommunications network 160.

In some embodiments, the database 115 is implemented as a series of tables containing interrelated data using methods that are well-known to those of ordinary skill in the art. In one specific exemplary embodiment, the database 115 comprises the tables and fields illustrated in the example below.

### EXAMPLE

ACCOUNTS CATEGORY

Daily AccountStats
[Date]
Account ID
GrossValue
Net Transfers
Index Value
BenchmarkID
FIMarketValue
FIBookValue
AmortizedCost
Amortization
AccruedInterest
EQMarketValue
EQBookValue
UnrealGain
UnrealLoss
AccountBal
Payables
AccountTimeStamps
ID
AccountID
[TimeStamp]
Type
Aggregates
AggregateID
Account ID
User Account Authority
UserID
Account ID
DisplayOrder
AccountSTIFunds
AccountID
STIFID
Amount
Accounts
ID
Name
ShortName
Balance
Receivables
Payables
Aggregate
Active
Demo
Reconcile
Managed
DailyStats
Amortize
AmortMethod
WALEffMaturity
ShiftAccrual
PreRefundUsage
RatingUsage
AuctionClass
Compliance View
BenchmarkID
Spread
DefaultSTIFID
ClientID
AccountType
CurrencyID
CustodyBankID
CustodyAcctNum
TaxIDnum
InvoiceFreq
AccountToInvoice
PaysMgmtFee
CalendarID
PerfCalendarID
BalanceBuffer
RatingUsage
ID
Description
Clients
ID
Name
ShortName
AbbrName
TaxID
Active
Calendars
Name
ShortName
DayOfWeek
AdvanceAccrInt
YearEndReference
STIFunds
ID
Cusip
Name
ShortName
BloombergSymbol
Rate
Benchmark
ID
Description
InvestmentStyle
Duration
Yield
BloombergSymbol
PriceOrYield
CloseDate
ClosePrice
Hybrid
CalendarDates
CalendarID
[Date]
[Month]
Quarter
[Year]
PeriodEndType
CustodyBanks
ID
Name
ShortName
Address
DTCnum
AgentNum
InstutionNum
DeliveryInstructions
CashInstructions
DivConPdn

USERS CATEGORY

UsersLoggedIn
ID
SessionID
LoginTime
UserAccountAuthority
UserID
AccountID
DisplayOrder
Permissions
PageID
UserID
[View]
Modify
MenuViews
MenuItemID
[View]
[Level]
Users
ID
FirstName
MI
LastName
Username
PWHashValue
Phone
Email
PermitBitMask
ClientID
Active
ViewType
Type
PasswordFlag
MenuItems
ID
Name
Link
Description
Clients
ID
Name
ShortName
AbbrName
TaxID
Active

SECURITIES CATEGORY

PriceHistory
Cusip
[Date]
Price
IntAcc
AccrInt2
Yield
Duration
Factor
RateHistory
Cusip
[Date]
Rate
BeginDate
EndDate
STIFHistory
STIFundID
[Date]
Rate
STIFunds
ID
Cusip
Name
ShortName
BloombergSymbol
Rate
smCreditRatings
ID
Bucket
SandP
Moody
Fitch
BBCComposite
SimpleWeight
ComplexWeight
SecurityMaster
ID
Cusip
ISIN
IDKey
Active
TypeID
DisplayType
DownloadConfig
DataStatus
PricingSource
Name
ShortName
Issuer
Underwriter
ParentCompany
Ticker
IssueDate
MaturityDate
AccrIntDate
PriceScalar
Price
Discount
Yield
YieldToWorst
YieldToCall
YieldToMaturity
IntAcc
SettleAccrInt
Coupon
ZeroCoupon
CpnFrequency
CpnResetFreq
PrevResetDate
NextResetDate
CpnPayConvention
VariableRate
Auction
Floater
Sinkable
Euro
smTypes
ID
Name
ShortName
Class1
Class2
Class3
Class4
Countries
Code
Name
Currencies
ID
Code
ISONum
Description
smFISectors
ID
Name
BBIndustry
BBIndustrySubGroup
smEQIndustrySectors
ID
Name
ShortName
BBIndustrySector
smMuniSectors
ID
Description
BBvalues
smClasses
Class1
Class2
Class3
Class4
Name
ShortName
smParentCompanies
ID
Name
ShortName
DayCounts
ID
MapID
Description

LOTS/TRANSACTIONS CATEGORY

Lots_New
ID
AccountID
Cusip
BuyTradeID
SellTradeID
SoldAmount
Notional
BeginDate
EndDate
[Exception]
TradeTransfers
ID
TradeID
AccountID
[Date]
Price
AccrInt
Factor
Trades
ID
TradeGroupID
Sequence
AccountID
Cusip
Trader
CounterPartyID
AcquireDate
TradeDate
SettleDate
PostDate
EffMaturityDate
Discount
Price
EntryPrice
Yield
Notional
IntAcc
Factor
Commission
Proceeds
BuyOrSell
Type
UnWindDate
Status
Note
CashEntries
ID
AccountID
Currency
CurrencyID
Amount
EntryDate
SettleDate
PostDate
xDate
Category
STIFID
Cusip
TradeID
Status
Traders
ID
FirstName
LastName
TradeTypes
ID
ShortName
Name
Description
CounterParties
ID
ShortName
Name
cpDTC
AgentNum
InstitutionalNum
DeliveryInstructions
CashInstructions
Active
CECategories
ID
Type
Code
Description
Currencies
ID
Code
ISONum
Description

COMPLIANCE CATEGORY

ComplianceRules
ID
[Section]
Level1
Level2
Level3
Name
SecurityType
ActualOnly
MaxOrMin
DefaultValue
MaxValue
MinValue
PercentBasis
NumberFormat
ComplianceHistory
ID
AccountID
[Date]
RuleID
Limit
Actual
ComplianceRuleValues
RuleID
AccountID
Limit
Actual
ComplianceSections
ID
Name
ComplianceReports
UserID
AccountID
ComplianceParams
UserID
NonComplianceOnly
ComplianceReportLog
ID
UserID
[TimeStamp]
MessageSent

CUSTODY DATA CATEGORY

CustodyBanks
ID
Name
ShortName
Address
DTCnum
AgentNum
InstitutionalNum
DeliveryInstructions
CashInstructions
DivCpnPdn
CUSTLogins
ID
CustodyID
URL
Username
Password
CUSTTransMap
CustodyID
TransID
CustCode
Description
Reviewed
CUSTPositions
AccountID
EntryDate
Cusip
Notional
Price
AccrIntUnit
MarketValue
OriginalPrice
AmortizedPrice
UGL
OriginalCost
OriginalFace
Factor
MaturityDate
Coupon
Yield
AccrIntDol
SP
Moody
Fitch
Duration
Description
CUSTCusipMap
AccountID
Cusip
CustCusip
MaturityDate
Coupon
Reviewed
CUSTTaxlots
AccountID
EntryDate
Cusip
Notional
OriginalPrice
AmorizedPrice
AccrInt
TradeDate
SettleDate
EffectiveMaturity
EffectiveYield
Factor
Proceeds
CUSTTransactions
ID
AccountID
EntryDate
Cusip
TradeDate
SettleDate
Type
CustodyType
Notional
Price
Principal
AccrInt
Amount
RealizedGL
Description
Status
CUSTReconciliationLog
AccountID
EntryDate
AutoReconcile
NumTransToProcess
AcctHasRun
AcctCleared
NumTransSuccess
NumTransProblem
CustCash
CWCashBefore
CWCashAfter
PendingAmt

Operation

In some embodiments, the overall operation of the management terminal 105 can be subdivided into the following functions: (a) Data Retrieval and Extraction; (b) Reconciliation; (c) Validation and Error Checking; and (d) Data Reporting and Display. Each of these functions is described in more detail below.

Data Retrieval and Extraction

In some embodiments, the data stored in the database 115 is organized as a series of accounts, each of which includes information in the following areas: accounting, positions, tax lots, and transactions. In some embodiments, the data stored in each of these areas for a given account is illustrated in Table 1, below.

TABLE 1

| Accounting: | Tax lots: | Transactions: | Positions: |
|---|---|---|---|
| Cash balance | Cusip | Cusip | Cusip |
| Total market value | Notional | Trade date | Notional |
| Total accrued interest | Trade date | Settle date | Market price |
| Total amortized cost | Settle date | Transaction type | Market value |
| Total original cost | Original price | Notional | Original price |
| Total unrealized gain/loss | Amortized price | Price | Amortized price |
| | Accrued interest | Principal | Original cost |
| | Effective maturity | Accrued interest | Amortized cost |
| | Effective yield | Amount | Unrealized gain/loss |
| | Current factor | Realized gain/loss | Original face |
| | Proceeds | Security name | Current factor |
| | Security name | | Previous factor |
| | | | Maturity date |
| | | | Coupon |
| | | | Yield |
| | | | Accrued interest |
| | | | SP rating |
| | | | Moody rating |
| | | | Fitch rating |
| | | | Duration |
| | | | Security name |

In some embodiments, when a new account is established, the user can select or define a customized set of accounting, compliance, risk, and performance parameters for the account. For example, the user may select a set of accounting assumptions for the new account, including parameters such as, but not limited to, the following: (a) a trade date or a settlement date accounting methodology; (b) a straight-line or a scientific/constant yield amortization method; (c) an amortization method in which transactions are amortized to the first par call and accreted to the legal final maturity or amortized to the final maturity; (d) static effective maturity dates on pre-paying/embedded option securities (including callable bonds, ABS, MBS, etc.); (e) a tax lot or an average cost security costing method; (f) a first in, first out (FIFO), last in, first out (LIFO), or average cost bond inventory method; and/or (g) customizable FAS115 balance sheet classification reporting parameters.

In operation, the I/O module 120 of the management terminal 105 retrieves the accounting, position, tax lot, and transaction data from the custody data sources 150, which include systems maintained by various custody banks and money managers.

In some embodiments, a custom report-access script is written for each individual custody data source 150 and executed at selected intervals, such as once per day, to simulate the actions a user would take to log in to the appropriate system, get to the reports containing the desired information, and download the reports to the user's computer. In many cases, the custody data sources 150 can be accessed using a conventional telecommunications protocol, such as HTTP or FTP, and the reports are made available in a standard, commonly-used format, such as HTML or CSV. In other cases, scripts can be developed to access a custody data source 150 using a non-standard telecommunications protocol or to retrieve data in a non-standard format. The data is typically stored in the database 115 in its raw format for historical purposes.

Once the raw data has been retrieved from the custody data sources 150, the I/O module 120 processes the data and extracts relevant information. A custom website parser is often used to perform this process because there can be significant differences between custody data sources 150 with respect to a variety of issues, such as account data formats, number of required fields, and account data quality. Several examples of common variations among custody data sources 150 are described below.

Some systems provide amortized price but not original price, whereas other systems provide both fields. Many systems identify securities using industry-standard cusips, but some systems provide proprietary security identifiers instead. In some systems, cusips are not provided, whereas in other systems, cusips are provided, but are not correct. In still other systems, cusips are provided, but only on some reports. In some systems, required fields are not available, whereas in other systems, required fields are not directly available, but can be calculated from available data.

Due to these and other variations between systems, a custom website parser is typically developed for each distinct custody data source 150. These custom website parsers can advantageously extract information from disparate custody data sources 150, convert the information into a standardized, uniform data format, and store it in the database 115 using methods that are well-known to those of skill in the art.

For example, in some embodiments, a website parser identifies a position, tax lot, or transaction by associating the position, tax lot, or transaction with a cusip. As discussed above, in some cases, system data contains cusips on certain reports, but not on others. In these cases, the parser can reference security characteristics (e.g., description, coupon, issuer, notional, maturity, price, coupon, market value, etc.) on a report that does not contains cusips and find a match on reports that do contain cusips. Since security characteristics do not always match exactly from report to report, the parser can intelligently determine which match is the best by comparing available characteristics. When a match is found, a cusip is assigned to the security on the report that did not contain cusips.

If cusips are not provided, or if they are not correct, the website parser can map the system identifier used for a given security, or “fake cusip,” to the industry-standard identifier for the security, or “real cusip.” In some embodiments, this mapping occurs by checking each potentially fake cusip against a cusip-mapping table. A fake cusip combined with a maturity date form a unique key that enables the parser to map the fake cusip to the real cusip automatically.

In some embodiments, if a required field is missing from a report, the website parser determines whether the missing value can be calculated from available fields. For example, if amortized price is not available, but unrealized gain/loss, notional, and market price exist on the reports, the parser can compute the value for amortized price using known techniques that are well-understood by those of ordinary skill in the art. The parser typically only computes a value when it is not available on the custody or manager report. Once all of the expected data for an account has been gathered, a timestamp is recorded that marks the success of the data extraction.

The I/O module 120 of the management terminal 105 also retrieves data from security data sources 155, which are typically maintained by service providers such as Merrill Lynch, Goldman Sachs, etc. In some embodiments, this data is stored in an “Index Data” table in the database 115, which includes fields such as a unique identifier, issuer, coupon, maturity date, price, position count, duration, yield, weighted average maturity, average credit rating, etc.

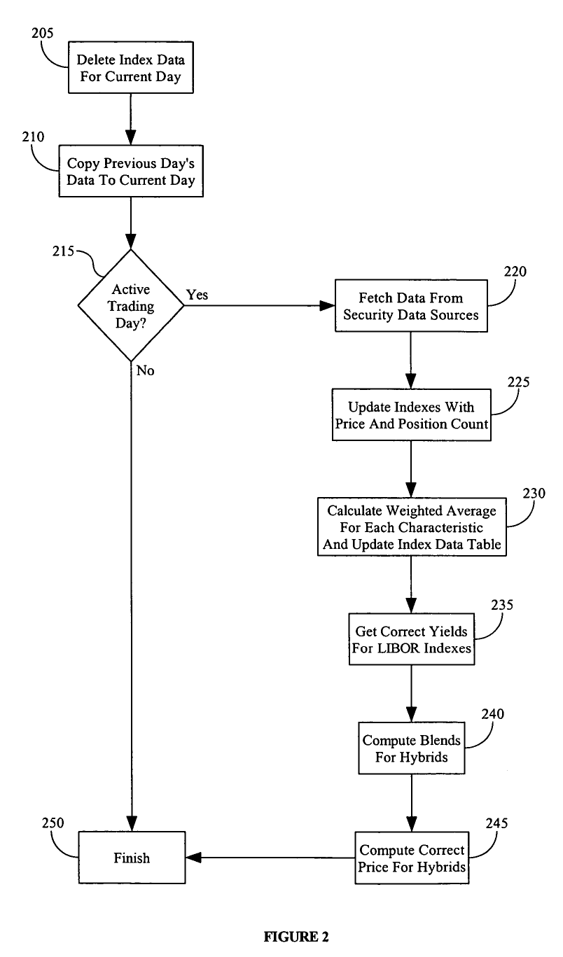

FIG. 2 illustrates one embodiment of a process for updating the Index Data table. Similar processes can be implemented to update other tables within the database 115. In the illustrated embodiment, the process is executed once per day. In other embodiments, the process may be executed at a different selected interval. In a first step 205, any data stored in the Index Data table for the current day is deleted. In a next step 210, the previous day's data is copied to the table for the current day. In a step 215, a determination is made as to whether the current day is an active trading day. If not (e.g., if the current day is a Saturday or Sunday), then the process skips to step 250, where the process ends.

Otherwise, the process continues to step 220, in which the I/O module 120 fetches data for the current day from one or more security data sources 155. This step can be carried out using a custom report-access script, as described above in connection with the custody data sources 150. Where possible, characteristics for securities which are members of standard (non-hybrid) indexes are retrieved from the security data sources 155.

In a step 225, the current value and position count for the standard indexes within the Index Data table is updated with the data retrieved from the security data sources 155. In a next step 230, a weighted average is calculated for each characteristic, and the Index Data table is updated accordingly. In a step 235, the correct yield for London Inter Bank Offering Rate (LIBOR) indexes is retrieved.

In a next step 240, data is retrieved from the database 115 for all indexes that are members of a hybrid index, and a weighted value is created based on hybrid weighting for each characteristic except price. Then, in a step 245, the correct price for the hybrid indexes is computed. This step comprises adding the weighted values (except price) for all indexes in each hybrid index to calculate hybrid index values, and updating the hybrid index values using these calculations. The hybrid index price is then updated by calculating price performance of each member index, multiplying performance by the hybrid weightings, adding the weighted values for each hybrid index (which yields performance for the hybrid index), and multiplying the previous hybrid index values by the hybrid index performance. In a final step 250, the process ends.

Reconciliation

In some embodiments, the reconciliation module 142 of the management terminal 105 periodically performs an automatic reconciliation process, in which account security characteristics are modeled using methods included in the investment analysis and reporting system and forecasted cash flows are entered automatically for expected transactions such as coupons, pay downs, dividends, and maturities. This process is carried out by an auto-reconciler, which automatically clears (without manual user intervention) predicted transactions that appear in the data retrieved from the custody data sources 150, and enters transactions that are not predicted.

In some embodiments, transactions are divided into two categories: trades and cash entries. The auto-reconciler enters trades into the database 115 by analyzing pertinent trade information such as cusip, trade date, settle date, notional, and price. The results of calculations that use independent bond characteristics of the management terminal administrator can be compared against custody results. If the results match, then the cash balance of the appropriate account is adjusted by the amount of the trade's proceeds.

The auto-reconciler also matches cash entries received from the custody data sources 150 with cash entries predicted by the management terminal 105. If there is a match, then the cash entry is cleared, and the cash balance of the appropriate account is adjusted accordingly. In addition, the auto-reconciler handles problems that can arise with transactions received from the custody data sources 150, such as, for example: (a) canceled transactions; (b) coupons, pay downs, and dividends reported by tax lot or by position; and (c) trade or cash entry amount discrepancies (off by a selected allowable limit, such as $0.01).

Once the received transactions have been processed, the auto-reconciler confirms that the cash balance, original cost, amortized cost, accrued interest, unrealized gain/loss and/or market value for the specified account in the database 115 match the cash balance, original cost, amortized cost, accrued interest, unrealized gain/loss and/or market value for the account in the corresponding custody data source 150. In some embodiments, the auto-reconciler includes a reporting system that displays items such as actions taken by the auto-reconciler, error messages, and suggestions to fix problem transactions.

In some cases, the automatic reconciliation process is not able to correctly handle one or more transactions. In these cases, the transactions are flagged for manual reconciliation. The manual reconciliation system presents users with information needed to correctly handle transactions that were not reconciled by the auto-reconciler, and provides users with the functionality needed to manually reconcile the transactions, as described in more detail below.

In some embodiments, the automatic and manual reconciliation processes are implemented in tables entitled “BOReconStatus” and “BOReconStates” within the database 115. The BOReconStatus table bridges information found in the “CUSTTransactions” and “CashEntries” tables. One exemplary embodiment of the BOReconStatus table is illustrated in Table 2, below.

TABLE 2
BOReconStatus

ID
EntryDate
AccountID
CUSTID
CWADID
CECategoryID
ChangeDate
State
ManualMatch

In this embodiment, the ID field comprises an integer ID field. The EntryDate field indicates the date on which the entry was made. The AccountID field contains the ID of the account corresponding to the entry. The CUSTID field contains the CUSTTransactions ID for the entry; this field may be null. The CWADID field contains the CashEntries ID corresponding to the entry; this field may also be null. The CECategoryID field contains the CashEntries category type for the entry. The ChangeDate field indicates the date on which the State field was last changed. The State field indicates the state corresponding to the ID field in the BOReconStates table. The ManualMatch field contains a zero if the entry was automatically matched or a one if the entry was manually matched.

The BOReconStates table enumerates the states in which transactions can exist. One exemplary embodiment of the BOReconStates table is illustrated in Table 3, below.

TABLE 3
BOReconStates

ID
Code
Description

In this embodiment, the ID field comprises an integer ID field. The Code field contains a three-letter code representing the state of a given transaction. The Description field contains a text description of the state.

The BOReconStatus table provides matching between the data in the database 115 and the data from the custody data sources 150. If the CUSTID field is null, the row represents a transaction that is in the CashEntries table but not in the CUSTTransactions table. If the CWADID field is null, the row represents a transaction that is in the CUSTTransactions table but not in the CashEntries table. If neither field is null, the row represents a match between a transaction in the database 115 and in the corresponding custody data source 150.

The BOReconStatus table is maintained by triggers created on the CUSTTransactions and CashEntries tables. These triggers maintain matching between the data stored in the database 115 and the data stored in the custody data sources 150, as described above. In some embodiments, matching is based on the following criteria: Account ID, Cusip, Settle date, Trade date (trades), Transaction type, Amount (cash entries), Price (trades), and Notional (trades).

An “INSERT” trigger in the CUSTTransactions or CashEntries table either matches an existing transaction according to the above fields and updates the appropriate row in the BOReconStatus table, or if no match exists, inserts a new row into the BOReconStatus table. A “DELETE” trigger in the CUSTTransactions or CashEntries table either breaks a match by setting the CUSTID or CWADID field to null in the BOReconStatus table, or deletes a row in the BOReconStatus table in the case that both the CUSTID and CWADID fields are null. An “UPDATE” trigger helps maintain the correct state in the BOReconStatus table by changing the State field in the BOReconStatus table if the Status field in the CECashEntries table is updated. In some embodiments, there is no UPDATE trigger for the CUSTTransactions table.

In addition to triggers, several stored procedures can be used to maintain correct matching in special circumstances. For example, if a previously matched system transaction is edited, it may or may not need to have its matching “broken.” If a stored procedure is necessary, it is typically run immediately after the action that requires it. In some embodiments, the following stored procedures are used to access transactions in particular states, and modify the states of the transactions: BOReconGetNew, BOReconGetUncleared, BOReconGetHeld, BOReconGetCleared, and BOReconHoldTransaction, BOReconUnholdTransaction.

In general, the manual reconciliation process includes the following steps: (1) select an account to reconcile; (2) determine which, if any, transactions need to be manually reconciled, and (3) take appropriate action to reconcile the selected transactions. In some embodiments, this process is implemented on a series of active server page (ASP) web pages.

The initial page is a list of accounts that have not been reconciled for the day. These accounts are ordered by priority as defined in the Accounts table of the database 115. Clicking on an account selects that account and takes the user to the transactions page. In some embodiments, the transactions page is divided into four sections: New, Uncleared, Held, and Cleared. These sections contain a list of transactions that belong to the state represented by the respective sections. The stored procedures described above can be used to populate the sections. Each section has associated actions that can be applied to one or more transactions. In some embodiments, these actions include: Enter, Delete, Hold, Clear, Unclear, Unhold, and Edit.

Validation and Error Checking

The management terminal 105 may use a number of routines to perform validation and error checking on data retrieved and used in the system. In some embodiments, these routines fall into three general categories.

The first category of validation deals with comparisons between the data stored in the database 115 and the data stored in the custody data source 150 from which it was derived. For example, the database 115 should show the same number of positions that the custody data source 150 shows. Values such as notional, purchase price, accrued interest, coupon, and maturity date in the database 115 should also match the data in the corresponding custody data source 150.

The second category of validation involves verifying that the database 115 contains valid values. This category includes checking for fields containing no value or an invalid value. For example, there are certain calculated values across multiple tables of the database 115 that should reconcile. In addition, some bond characteristics are not required for system reporting, while other bond characteristics are required. Constraints such as these are verified and enforced as part of the second category of validation.

The third category of validation involves ensuring that the values actually reported to the user by the management terminal 105 are accurate and reconcile correctly across all reports. This category of validation occurs when reports are displayed by the management terminal 105 in response to user requests, as described in more detail below.

Data Reporting and Display

Individuals operating user terminals 165 can gain access to the management terminal 105 via the telecommunications network 160. In some embodiments, the management terminal 105 functions as a web-based application using the secure sockets layer (SSL) protocol to ensure a secure connection. A user typically must provide certain login information (e.g., a username and password) to gain access to the management terminal 105.

Once a user has logged into the management terminal 105, the user can access a number of reports which apply various analytics and security pricing tools to the data within the user's account. For example, the management terminal 105 can provide account characteristics such portfolio accounting, compliance, risk and performance including analytics such as, for example, value at risk, attribution, shock testing information, equity driven credit score, etc. In some embodiments, the management terminal 105 is capable of providing book-of-record investment accounting information that can be used by a company to satisfy the regulatory disclosure and reporting requirements of governmental agencies, such as the Financial Accounting Standards Board (FASB) and/or securities and exchange commission (SEC).

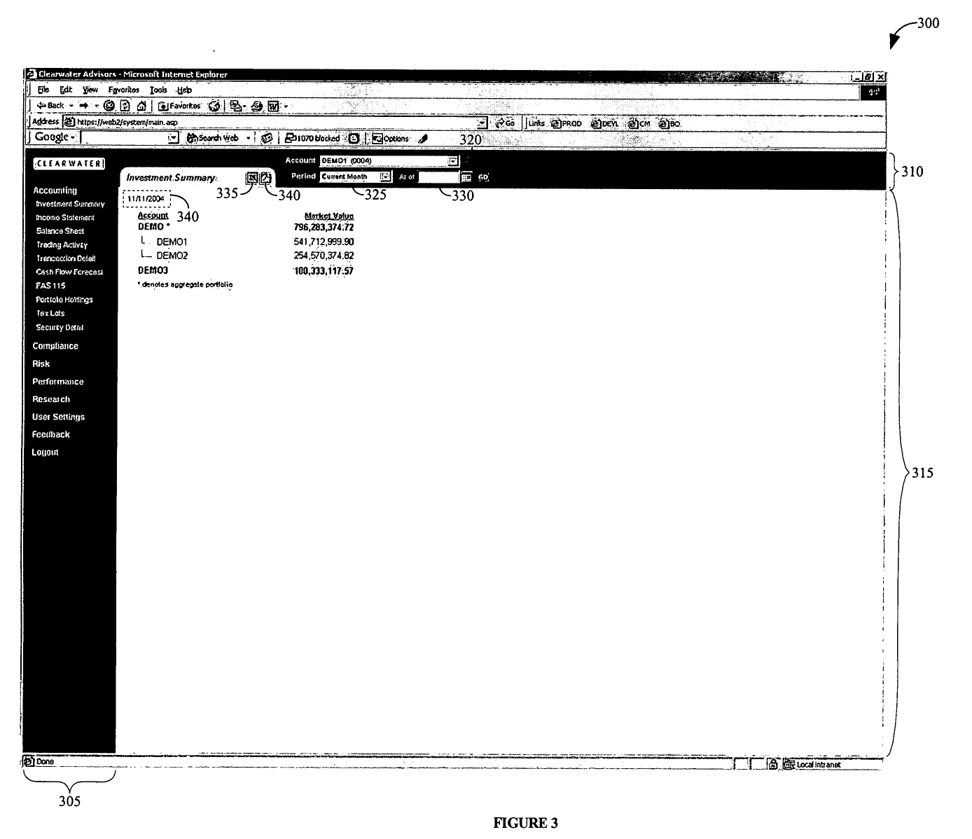

FIG. 3 illustrates one embodiment of a screen 300 that may be displayed to a user who has logged into the management terminal 105. In the illustrated embodiment, the screen 300 comprises three HTML frames: a Menu Frame 305, a Header Frame 310, and a Data Frame 315.

In some embodiments, the Menu Frame 305 contains links to the reports available to the user through the management terminal 105. The Menu Frame 305 may utilize an expandable menu system categorized by sections, such as, for example, Accounting, Compliance, Risk, Performance, and Reconciliation.

In some embodiments, the Header Frame 310 indicates the title of the report currently being viewed, and provides controls to access a number of functions within the management terminal 105. A number of exemplary controls and their associated functions are described below. An Account Selection Box 320 allows users to run reports for different accounts. A Period Selection Box 325 allows users to run reports for a given period such as the current month, previous month, current quarter, etc. These periods are defined based at least in part on inputs received from the user and generally consistent with the user's fiscal accounting schedule. One or more Custom Date Box(es) 330 allow users to select a custom date or date range, depending on the type of report viewed. A Spreadsheet Download Button 335 allows users to download the current report data into a spreadsheet application. A PDF Download Button 340 allows users to download the current report data into a PDF document.

In some embodiments, the Data Frame 315 acts as the frame in which data for a given report is displayed. On many reports, the Data Frame 315 includes a date or date range in a designated area 345, such as the upper left corner of the frame, which displays the time period of the report being shown.

In some embodiments, users view reports by expanding the menu of the appropriate category in the Menu Frame 305 and selecting the title of the desired report. The user can then select the desired account and reporting period using the Account Selection Box 320, Period Selection Box 325, and Custom Date Box(es) 330 in the Header Frame 310. The appropriate module of the management terminal 105 then generates the requested report, which is displayed to the user in the Data Frame 315. Examples of reports that may be generated by the accounting module 125, compliance module 130, risk module 135, and performance module 140 of the management terminal 105 are described below.

In some embodiments, the accounting module 125 is capable of generating a number of reports, such as, for example, an Investment Summary report, an Income Statement report, a Balance Sheet report, a Trading Activity report, a Transaction Detail report, a Cash Flow Forecast report, a FAS 115 report, a Portfolio Holdings report, a Tax Lots report, and a Security Detail report. Each of these reports is described below.

The Investment Summary report provides summary information for all the accounts the user has access to view for a specified date. This information may include market value, return, compliance and reconciliation status for each account. If an account is a sub-account of an aggregate account, it is typically shown grouped under the appropriate aggregate account.

The Income Statement report provides income data for a specified account and period. This data is presented as a running total and provides beginning and ending capital values. Other values delineated within the report include: Transfers In, Transfers Out, Realized Gains, Realized Losses, Amortization, Accretion, Interest Income, Dividend Income, Expenses, and Profit/Loss Impact.

The Balance Sheet report provides values for a specified account and date. These values include: Book Value, Amortization, Accretion, Amortized Cost, Accrued Interest, Amortized Cost (with Accrued Interest), Unrealized Gain, Unrealized Loss, and Total Market Value.

The Trading Activity report provides all trading activity for a specified account and period including buys, sells, redemptions, maturities, and security transfers. The report displays the following fields for each transaction: Trade Date, Settle Date, Trade Type, Cusip, Description, Coupon, Maturity Date, Dealer, Original Face, Notional, Price, Principal, Accrued Interest, Realized Gain/Loss, Cash Equivalents or Marketable Securities and Proceeds. The rows displayed may be sorted by any given column in ascending or descending order by clicking on the desired column. Each value in the Cusip column is a link to a window that displays detail for that security, as described below in connection with the Security Detail report.

The Transaction Detail report provides all transactions for a specified account and period including trades (including all types listed for the Trading Activity report), coupon payments, principal paydowns, dividends, and cash transfers. The report typically displays the following fields for each transaction: Trade Date, Settle Date, Transaction Type, Notional, Cusip, Description, Coupon, Maturity, Price, and Amount. The rows displayed may be sorted by any given column in ascending or descending order by clicking on the desired column. Each value in the Cusip column is a link to a window that displays detail for that security, as described below in connection with the Security Detail report.

The Cash Flow Forecast report displays cash forecasting data for a specified account for a specified number of days into the future. The report forecasts cash flows including coupons payments, maturities, and other income that can be predicted based upon the security characteristics of the current holdings. The report is divided into sections based on individual days with each day containing the predicted cash flows to come in on that day. Each section contains a total cash flow value and ending cash balance value for that day. Within the section, each cash flow typically displays the following fields: Transaction Type, Cusip, Description, and Amount. Each value in the Cusip column is a link to a window that displays detail for that security, as described below in connection with the Security Detail report.

The FAS 115 report provides total values for purchases and sales for a given account for a given period. These purchases and sales are divided into three sections in the top portion of the report, namely, Cash Equivalents, Short Term/Long Term Investments, and Totals. The bottom portion of the report displays the tax lots for the account on the ending date of the selected range categorized into three sections, namely, Cash, Short Tern, and Long Term. These sections are defined using categorization set out in the FAS 115 regulatory guidelines. Each tax lot displayed within these three sections includes the following fields: Account, Cusip, Original Face, Current Face, Description, Security Type, Sector, Cash Equivalent/Marketable Securities (CE/MS), Coupon, Maturity, Effective Maturity, Purchase Yield, Yield, Settle Date, Original Cost, Amortized Cost, Unrealized gain/loss, Price, Accrued Interest, Market Value. Each value in the Cusip column is a link to a window that displays detail for that security, as described below in connection with the Security Detail report.

The Portfolio Holdings report provides a list of security positions for a specified account and date. The positions are divided up into three sections, namely, Cash, Fixed Income, and Equities. Within the Cash section, the following fields are typically displayed for each position: Cusip, Description, Yield, and Market Value. Within the Fixed Income section, the following fields are typically displayed for each position: Cusip, Notional, Description, Rating, Coupon, Maturity, Amortized Price, Market Price, Yield, Accrued Interest, Unrealized Gain/Loss, and Market Value. Within the Equities section, the following fields are typically displayed for each position: Cusip, Shares, Description, Original Price, Market Price, Yield, Trailing P/E, Beta, Unrealized Gain/Loss, and Market Value. Each value in the Cusip column is a link to a window that displays detail for that security, as described below in connection with the Security Detail report.

The Tax Lots report provides a list of tax lots for a specified account and date. The lots are divided up into three sections, namely, Cash, Fixed Income, and Equities. Within the Cash section, the following fields are typically displayed for each lot: Cusip, Description, Yield, and Market Value. Within the Fixed Income section, the following fields are typically displayed for each lot: Cusip, Original Face, Current Face, Description, Coupon, Maturity, Effective Maturity, Purchase Yield, Yield, Settle Date, Unrealized Gain/Loss, Original Price, Original Cost, Amortized Price, Amortized Cost, Market Price, Accrued Interest, and Market Value. Within the Equities section, the following fields are typically displayed for each position: Cusip, Shares, Description, Yield, Trade Date, Unrealized Gain/Loss, Original Price, Original Cost, Market Price, and Market Value. Each value in the Cusip column is a link to a window that displays detail for that security, as described below in connection with the Security Detail report.

The Security Detail report provides a list of tax lots for a specified account and date. The lots are divided up into three sections, namely, Cash, Fixed Income, and Equities. Within the Cash section, the following fields are typically displayed for each lot: Cusip, Ticker, Description, Yield, and Market Value. Within the Fixed Income section, the following fields are typically displayed for each lot: Cusip, ISIN, Ticker, Description, Issuer, Underwriter, Security Type, Sector, SIC Code, Currency, Issue Date, Amount Outstanding, S&P Rating, Moody's Rating, Fitch Rating, Coupon, Coupon Type, Frequency, Day Count, First Coupon Date, Municipal Pre-Refund Status, Municipal Insurer, State Code, Alternative Min Tax, Municipal Issue Type, Municipal Sector, Next Call Date, Next Call Price, Next Put Date, Next Put Price, Trade Date, Settle Date, Maturity Date, Effective Maturity Date, Yield, Purchase Yield, Duration, Factor, Original Face, Current Face, Unrealized Gain/Loss, Original Accrued Interest, Original Price, Original Cost, Amortized Price, Amortized Cost, Market Price, Accrued Interest, and Market Value. Within the Equities section, the following fields are typically displayed for each position: Cusip, ISIN, Ticker, Description, Sector, SIC Code, Currency, Shares, Yield, Trailing P/E, Beta, Trade Date, Settle Date, Unrealized Gain/Loss, Original Price, Original Cost, Market Price, and Market Value. Each value in the Cusip column is a link to a window that displays detail for that security.

In some embodiments, the compliance module 130 is capable of generating a number of reports, such as, for example, a Compliance Guidelines report, a Compliance Violations report, a Compliance History report, a Management Agreement report, and a Credit Watch report. Each of these reports is described below.

The Compliance Guidelines report provides an interface for the user to view and modify rules set for a specified account. In some embodiments, the rules are categorized under one of seven sections, namely, Duration, Sectors, Credit, Concentration, Currency, Liquidity, and Trading. Only rules used by the specified account are displayed on the report under the section to which it belongs. If there are no rules being used for a given section, that section will not be shown on the report. This enables the report to be dynamic in nature by only showing the rules pertinent to the account. Each rule consists of a description, a limit value and an actual value. The actual value is the actual calculated value for the account with respect to that rule. The limit value can be set by the user and is used to determine when the account is out of compliance for a given rule. Permissions maintained in the database 115 allow the modify capability to be disabled for a specified user, making the report read-only to them. When an account is out of compliance due to a particular rule, that rule is highlighted on the report.

The Compliance Violations report provides detailed information regarding compliance violations for a specified account. Each rule that is out of compliance is displayed on the report. Under each violation, the positions causing the particular violation are displayed. Fields included for each position are the following: Cusip, Description, Coupon, Maturity Date, Portfolio Pct, and Market Value. Each value in the Cusip column is a link to a window that displays detail for that security.

The Compliance History report provides historical compliance information for a specified account and time period. The report is presented in terms of days, where each day within the specified period is shown as compliant or non-compliant. If the account was non-compliant for a given day, the report will show which violations occurred on that particular day. The display for each violation includes the rule description, limit value, and actual value.

The Credit Watch report provides information on securities held in a specified account regarding their credit status. In some embodiments, the report is divided into two sections, namely, Downgrades and Upgrades. The report shows the securities that have been placed on downgrade or upgrade watch, and displays them under their respective section. The following fields are displayed for each position: Cusip, Notional, Description, Coupon, Maturity Date, S&P Rating, Moody's Rating, Fitch Rating, S&P Watch Status, Moody's Watch Status, Fitch Watch Status, Market Price, Yield, Accrued Interest, and Market Value.

In some embodiments, the risk module 135 is capable of generating a number of reports, such as, for example, a Risk Summary report, a Credit report, a Duration report, a Sectors report, an Issuer Concentration report, an Index Comparison report, and a VaR report.

The Risk Summary report is typically divided up into four sections. The first section contains a group of total values for the account, which include Cash Amount, Fixed Income Amount, Equity Amount, Average Duration, Yield, Average Credit Rating, Month To Date Return, and Compliance Status. The second section contains a pie chart displaying the account holdings categorized by duration bucket percentages. The third section contains a pie chart displaying the account holdings categorized by sector bucket percentages. The fourth section contains a pie chart displaying the account holdings categorized by credit rating bucket percentages. Each of the last three sections serves as a link to its corresponding risk report. For example, clicking on the Duration section graph takes the user to the Duration report.

The Credit Rating report displays the positions held for a specified account and date categorized by credit rating. The rating groups include, Cash, AAA, AA, A, BBB, A-1/P-1, A-2/P-2, Non-Investment and Not Rated. Each section displays the total value and percentage the account holds in each group as part of the section heading. Underneath each section, the positions for that group are displayed including the following fields: Cusip, Notional, Description, Coupon, Maturity Date, Rating, Price, Yield, Accrued Interest, and Market Value.

The Duration report displays the positions held for a specified account and date categorized by duration. The duration groups include, 0-3 Months, 3-6 Months, 6-9 Months, 9-12 Months, 1-2 Years, 2-3 Years, 3-4 Years, 4-5 Years, 5-7 Years, 10-15 Years, and 15-30 Years. Each section displays the total value and percentage the account holds in each group as part of the section heading. Underneath each section, the positions for that group are displayed including the following fields: Cusip, Notional, Description, Coupon, Maturity Date, Duration, Rating, Price, Yield, Accrued Interest, and Market Value.

The Sectors report displays the positions held for a specified account and date categorized by sector. The sector groups include Cash, Government, Agency, Municipal, Corporate, Asset Backed, and Mortgage Backed. Each section displays the total value and percentage the account holds in each group as part of the section heading. Underneath each section, the positions for that group are displayed, including the following fields: Cusip, Notional, Description, Coupon, Maturity Date, Rating, Price, Yield, Accrued Interest, and Market Value.

The Issuer Concentration report displays the positions held for a specified account and date grouped by the issuer of the security. The report groups the positions by issuer using the ultimate parent company of each security. Each section represents an issuer, and underneath each section the positions belonging to that issuer are displayed including the following fields: Cusip, Notional, Description, Coupon, Maturity Date, Rating, Price, Yield, Accrued Interest, and Market Value.

The Index Comparison report provides comparison between a specified account and its associated index for a specified date. These comparisons are typically divided into four sections. The first section is a summary section that compares the accounts values for Duration, Yield and Weighted Average Maturity against the index. The second section compares the account's Duration composition against the index. The third section compares the account's Sector composition against the index. The fourth section compares the account's Credit composition against the index. The Index Comparison report has two modes, one showing the four sections using bar charts, another showing the sections as actual values. A button allows the user to toggle between the two modes.

The VaR report provides Value at Risk information for a specified account and date. The report divides the VaR numbers for the fixed income portion, equity portion, and both combined. Values given for these sections include: Daily VaR, Monthly VaR, Number of Securities Held, and Total Value.

In some embodiments, the performance module 140 is capable of generating a number of reports, such as, for example, a Performance Summary report and a Monthly Performance report. Both of these reports are described below.

The Performance Summary report provides return values for a specified account. The report uses bar charts to display Total Return, Index Return, and Excess Return (i.e., the difference between total and index). The report displays values for the current month, current quarter, current year, previous month, and previous year.

The Monthly Performance report gives monthly return values for a specified account for the last 12 months. The report uses bar charts to display the values for each of the last 12 months. These values include Income Return, Price Return, and Total Return.

In some embodiments, the reconciliation module 142 is capable of generating a number of reports such as, for example, a Reconciliation Summary report, a Cash Reconcile report, a Book Value Reconcile report, a Market Value Reconcile report, an Accrued Interest Reconcile report, an Amortized Cost Reconcile report, an Unrealized Gain/Loss Reconcile report, and an Investment Summary report. Each of these reports is described below.

The Reconciliation Summary report compares values for a specified account with the custody bank values. The values displayed include: Cash, Book Value, Amortized Cost, Total Accrued, Market Value, and Unrealized G/L. For each of these values the report shows the total amount in the system, the total amounts from the custody bank, the difference between the system amounts and custody amounts, the unexplained portion of the difference, and the explained portion of the difference.

The Cash Reconcile report compares the cash value for a specified account with the custody cash value. The values displayed are the system cash amount, custody cash amount, difference between the system cash amount and the custody cash amount, the unexplained portion of the difference, and the explained portion of the difference.

The Book Value Reconcile report compares the book values for each lot for a specified account with the custody bank. The values displayed for each lot include system book value, custody book value, difference between the system book value and custody book value, the unexplained portion of the difference, and the explained portion of the difference.

The Amortized Cost Reconcile report compares the amortized cost for each lot for a specified account with the custody. The values displayed for each lot include system amortized cost, custody amortized cost, difference between the system amortized cost and custody amortized cost, the unexplained portion of the difference, and the explained portion of the difference.

The Total Accrued Reconcile report compares the total accrued for each lot for a specified account with the custody. The values displayed for each lot include system total accrued, custody total accrued, difference between system total accrued and custody total accrued, the unexplained portion of the difference, and the explained portion of the difference.

The Market Value Reconcile report compares the market value for each lot for a specified account with the custody. The values displayed for each lot include system market value, custody market value, difference between the system market value and custody market value, the unexplained portion of the difference, and the explained portion of the difference.

The Unrealized Gain/Loss Reconcile report compares the unrealized gain/loss for each lot for a specified account with the custody. The values displayed for each lot include system unrealized gain/loss, custody unrealized gain/loss, difference between system unrealized gain/loss and custody unrealized gain/loss, the unexplained portion of the difference, and the explained portion of the difference.

The Investment Summary report is described above.

In some embodiments, a user can select to receive some or all reports via electronic mail on a regular basis, such as daily, weekly, monthly, etc. In some embodiments, data can be reported to a user via a “treasury dashboard” interface, which displays a high-level summary of a variety of financial information in a convenient, integrated user interface. For example, the treasury dashboard may display summaries of a user's banking data, foreign exchange information, stock administration data, and investment data side-by-side in a single integrated user interface.

Conclusion

The systems and methods described above provide a number of distinct advantages over conventional approaches to institutional investment management. For example, by using the systems and methods described above, data can easily be retrieved from multiple sources, such as different custody/safekeeping banks, money managers, security information service providers, etc. This data can then be stored in a central database using a standard set of data formatting rules and accounting assumptions, so that it can be analyzed quickly and efficiently by a user such as an institutional investor.

In addition, by using the systems and methods described above, information in the database can be updated frequently, such as at least once per day, and users can access the information using any web-enabled device. As a result, users can advantageously retrieve information from the system virtually in real time, as opposed to receiving only periodic (e.g., monthly) reports, as is common in conventional approaches for reporting on institutional investments. This feature is particularly advantageous with respect to compliance data. Compliance violations can be recorded daily for audit purposes and made available for an extended period of time (e.g., a year) in a compliance history table. Thus, a user can detect compliance rule violations at any time, unlike conventional systems in which the user receives only a periodic “snapshot” indicating whether or not any compliance rules are violated at the moment the compliance report is generated.

In addition, by performing daily updates to the information in the database, a user can select whatever date is most convenient as the closing date for a given accounting period. For example, a user can select a custom, user-specific fiscal calendar closing period or date. As a result, the user is given much greater flexibility than is available in conventional investment management systems.

The systems and methods described above also advantageously enable institutional investors to access multiple categories of information (e.g., accounting, compliance, risk, performance, reconciliation, etc.) simultaneously from a convenient, integrated user interface. This feature is particularly advantageous with respect to the combination of accounting and compliance information, because institutional investors can establish compliance rules based on accounting parameters (e.g., realized gain/loss, effective maturity date, etc.) in addition to more traditional compliance parameters, such as risk requirements.

The risk platform of the systems and methods described above enables users to easily quantify a given manager's performance on an absolute basis or relative to a selected market index. As a result, users can advantageously evaluate the performance of selected managers and efficiently make strategic decisions regarding factors such as overall portfolio allocation using consistent assumptions and methodologies.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A management terminal of an institutional investment analysis and reporting system, the management terminal comprising:
an input/output module configured to retrieve and/or extract data from a plurality of disparate data sources in communication with the management terminal via a telecommunications network;
a database configured to store data retrieved from the data sources;
a reconciliation module configured to reconcile data stored in the database;
an accounting module configured to generate accounting reports from data stored in the database;
a compliance module configured to generate compliance reports from data stored in the database;
a risk module configured to generate risk reports from data stored in the database; and
a performance module configured to generate performance reports from data stored in the database.

2. The management terminal of claim 1, wherein the data sources comprise databases maintained by a plurality of independent custody/safekeeping banks or money managers.

3. The management terminal of claim 1, wherein the data sources comprise databases maintained by one or more security information service providers.

4. The management terminal of claim 1, wherein the accounting reports can be generated using customized methodologies and fiscal periods selected by a user.

5. The management terminal of claim 1, wherein the accounting module is configured to forecast cash flows and other income and expense.

6. The management terminal of claim 1, wherein the accounting module is configured to automatically download accounting close entries, transactions, and balances including investment debits and credits to a general ledger.

7. The management terminal of claim 1, wherein the compliance module is configured to monitor pre-trade, post-trade, and real-time market-driven compliance with appropriate accounting and risk compliance rules.

8. The management terminal of claim 1, wherein the data retrieved from the data sources comprises data related to one or more of the following investment instruments: money market funds, commercial paper, CDs, time deposits, treasuries, bonds, and auction rate preferred notes.

9. The management terminal of claim 1, wherein the data retrieved from the data sources comprises data related to equity products or to derivative investment products.

10. The management terminal of claim 9, wherein the derivative investment products comprise options, swaps, and futures.

11. The management terminal of claim 1, wherein the reconciliation module is configured to automatically confirm and reconcile data retrieved from the data sources and notify the user of discrepancies.

12. The management terminal of claim 1, wherein the data retrieved from the data sources comprises data related to a plurality of individual securities, and the reconciliation module is configured to provide a detailed, security-by-security reconciliation report daily.

13. The management terminal of claim 1, wherein the telecommunications network comprises the Internet.

14. A method for analyzing and reporting institutional investments comprising:
retrieving transaction data from multiple independent financial institutions and storing it in a database in a standardized format;
retrieving security data from one or more security information service providers and storing it in the database;
automatically reconciling the retrieved transaction and security data and notifying the user of discrepancies;
receiving a user request from a user terminal in communication with a management terminal via a telecommunications network, for a selected report of data stored within the database;
in response to the user request, generating the selected report by compiling data retrieved from the multiple independent financial institutions and displaying the report to the user.

15. The method of claim 14, wherein the selected report displays the after tax performance of a municipal/taxable hybrid investment account.

16. The method of claim 14, wherein the selected report displays performance attribution by duration, sector, and/or security selection.

17. The method of claim 16, wherein the selected report includes details on municipal/taxable and/or multi currency attribution.

18. The method of claim 14, wherein the selected report is transmitted to the user via electronic mail.

19. A method for reporting institutional investment information, comprising:
enabling a user to select a report of data related to any individual or all of the following characteristics of an institutional investment account: (a) accounting, (b) compliance, (c) risk, and (d) performance;
initially displaying a first report of the selected data at a summary level;
receiving a user request for more detailed information about the summary data displayed in the first report; and
in response to the user request, displaying a second, third or fourth report at a detailed level showing information about one or more specific securities within the institutional investment account.

20. The method of claim 19, wherein enabling the user to select a report comprises displaying a treasury dashboard user interface.

21. The method of claim 20, wherein the treasury dashboard user interface displays treasury-related activities including banking data, foreign exchange information, stock administration data, and investment data.

22. A method for analyzing and reporting institutional investments comprising:
retrieving transaction data from multiple independent financial institutions and storing it in a database in a standardized format;
retrieving security data from one or more security information service providers and storing it in the database;
applying a uniform set of accounting, compliance, risk and performance parameters to the transaction data and security data stored in the database;
in response to a user request, calculating and reporting selected data to the user in accordance with the uniform accounting, compliance, risk and performance parameters.

23. The method of claim 22, wherein retrieving transaction data and/or security data comprises executing one or more custom report-access scripts at selected intervals.

24. The method of claim 22, wherein transaction data and/or security data is retrieved using the HTTP or FTP conventional telecommunications protocol.

25. The method of claim 22, wherein transaction data and/or security data is retrieved in HTML or CSV format.

26. The method of claim 22, further comprising executing one or more custom parsers to extract selected information from the retrieved transaction data and/or security data.

27. The method of claim 22, wherein the accounting, compliance, risk and performance parameters can be defined by a user upon inception of a new institutional investment account.

28. The method of claim 22, wherein the accounting parameters comprise a trade date or a settlement date accounting methodology.

29. The method of claim 22, wherein the accounting parameters comprise a straight-line amortization method or a scientific/constant yield amortization method.

30. The method of claim 22, wherein the accounting parameters comprise an amortization method in which transactions are amortized to the first par call and accreted to the legal final maturity or amortized to the final maturity.

31. The method of claim 22, wherein the accounting parameters comprise static effective maturity dates on pre-paying/embedded option securities.

32. The method of claim 31, wherein the pre-paying/embedded option securities comprise one or more of the following securities: callable bonds, ABS, and MBS.

33. The method of claim 22, wherein the accounting parameters comprise a tax lot security costing method or an average cost security costing method.

34. The method of claim 22, wherein the accounting parameters comprise one or more of the following bond inventory methods: (a) first in, first out; (b) last in, first out; and (c) average cost.

35. The method of claim 22, wherein the accounting parameters comprise customizable FAS115 balance sheet classification reporting parameters.

36. The method of claim 22, wherein reporting selected data to the user comprises providing book-of-record investment accounting information.

37. The method of claim 22, wherein reporting selected data to the user comprises providing investment reporting and analytics services to an investment manager.

38. The method of claim 37, wherein the reporting and analytics services comprise one or more of the following account characteristics: (a) value at risk, (b) attribution, (c) shock testing information, and (d) equity driven credit score.

39. A method of monitoring compliance in an institutional investment system, the method comprising:
establishing a plurality of compliance rules for a user account based at least in part on inputs received from the user, wherein one or more of the compliance rules is based on accounting and/or risk parameters;
monitoring daily activity within the user account to detect violations of the compliance rules for the account on a daily basis; and
notifying the user of compliance rule violations within one day of when such violations are detected.

40. The method of claim 39, wherein compliance rule violations for short-term investment instruments are reported accurately.

41. The method of claim 40, wherein the short-term investment instruments comprise CDs or commercial paper.

42. The method of claim 39, wherein one or more of the compliance rules is based on risk parameters.

43. The method of claim 42, wherein at least one of the compliance rules is customizable based on user-specific accounting or risk parameters.
